(19) United States
(12) Patent Application Publication
(10) Pub. No.: US 2007/0234719 A1
(43) Pub. Date: Oct. 11, 2007

(54) ENERGY CONVERSION DEVICE AND OPERATION METHOD THEREOF

(76) Inventors: Alexander Schuster, Netanya (IL); Alexander Kramarenko, Fairlawn, NJ (US)

Correspondence Address: BRUCE E. LILLING;LILLING & LILLING PLLC, P.O. BOX 560, GOLDEN BRIDGE, NY, 10526, US

(21) Appl. No.: 11/278,934

(22) Filed: Apr. 6, 2006

(51) Int. Cl. F01B 29/08; F02G 1/04; F01K 25/00; F01B 29/10

(52) U.S. Cl. 60/520; 60/516

(57) ABSTRACT

The present invention suggested a new energy conversion device implementing regenerative gas cycle. The energy conversion device is comprised of: a work machine that is capable of receiving and transmitting variations of pressure, at least two displacer units each including a hot and cold zone and a displacer element for moving an actuating medium from the hot zone to the cold zone, at least one counterflow heat exchanger for enabling heat exchange between actuating mediums of displacer units, wherein the actuating medium of the displacers units flows through the counterflow heat exchanger from the hot zone to the cold zone and vice versa and a controlling device capable of controlling the movement of displacers elements, at least four conduits for connecting between the counterflow heat exchanger to the displacer units.

### BACKGROUND OF THE INVENTION

1. Field of the Invention

The present invention relates to an improved arrangement of heat exchanging portions of devices using regenerative gas cycle (e.g. Stirling cycle, Ericsson cycle, Vuilleumier cycle, Gifford McMahon cycle, Sibling cycle and similar) such as cryocoolers, heat engines, refrigerators and pumps. More particularly, the customary used regenerator is replaced by counterflow heat exchanger; heat machine is coupled with the heat accumulator or heat machine is coupled with another heat machine, operating in regenerative antiphase, by the said counterflow heat exchanger into one highly efficient device.

2. Description of the Related Art

The present discussion will be primarily directed to heat machines operating on a regenerative thermodynamic cycle with cyclic compression and expansion of the working fluid at different temperature levels using repeated heating and cooling of a sealed amount of working gas, usually air or other gases such as hydrogen or helium. Physical correlations between empirical parameters such as pressure, volume and temperature, instantiated by the statistical mechanics, dictates gas flow within the system, thereby converting gas volume changes and heat energy into mechanical work or vice versa. In principle, gas pressure rises when heated, delivering mechanical energy to the piston to produce a power stroke. Gas pressure is then drops when cooled, thereby decreasing recompression energy needed in the return stroke, and giving a net gain in power available on the shaft.

The total net of mechanical work gained by the thermodynamic process, is due to the difference in pressure between compressed hot gas and decompressed cold gas multiplied by the chamber volume. A “cycle efficiency” η, can then be defined as the proportion between total net work gained Qeff divided by the total thermal energy invested Qin.

η=Qeff/Qin

According to the “Carnot theorem” this efficiency ηis equal to the proportion between difference between the highest Thigh and lowest Tlow temperatures in the system divided by the highest Thigh temperature, thereby defining a “theoretical efficiency” boundary that can not be broken.

η=(Thigh−Tlow)/Thigh

It follows, that the cycle must contain methods of heating and cooling the gas within one cycle. The highest gas temperature within the cycle is gained by an external heat source while the lowest one is determined by the reservoir temperature. It follows that Qloss can be determined by subtracting Qin with Qeff.

Qloss=Qin−Qeff (FIG. 1).

Dissipation of waste heat is especially complicated because the coolant temperature is kept as low as possible to maximize thermal efficiency. This drives up the size of the radiators markedly which can make packaging difficult.

A known problem, common to all mentioned above heat devices, is finding efficient methods for reducing the amount of energy lost to the reservoir (Qloss). The problem was partly solved by the installation of a heat capacitor, commonly referred to as a “regenerator”. The process of which the regenerator is involved, allows a partial consumption of energy loss, by returning it back to the cycle as Qin. The other part, Qwaste is irreversibly lost to the reservoirs (FIG. 1). The regenerator is constructed of material that readily conducts heat and has a high surface area (e.g. a mesh of closely spaced thin metal plates). When hot gas is transferred to the cool chamber, it is first driven through the regenerator, where a portion of the heat is deposited. When the cool gas is transferred back, this heat is reclaimed; thus the regenerator “pre heats” and “pre cools” the working gas, improving efficiency and decreasing the need for large radiators. Nevertheless, regenerator's efficiency is limited, and requires a complex unit construction.

Referring to FIG. 6 prior art of regenerative gas Stirling cycle device is shown. The device can operate as heat engine or heat pump depending on the phase sequence of the gas flows and the phase sequence of double acting piston motion, which in turn, depending on the regenerative phase of the device. The device on FIG. 6 is disclosed in the U.S. Pat. No. 4,622,813.

Referring to FIG. 8 prior art of regenerative gas Gifford cycle device is shown. The device actually operates as a heat pump to produce extremely low temperatures. The device on FIG. 8 is disclosed in U.S. Pat. No. 2,966,035.

Referring to FIG. 10 prior art of regenerative gas Vuilleumier cycle device is shown. The device is assigned to obtain useful temperature effects. The device on FIG. 10 is disclosed in U.S. Pat. No. 1,275,507.

Referring to FIG. 12 prior art of regenerative gas Sibling cycle device is shown. The device is for achieving the Sibling cycle variant of the Stirling/Ericsson type of regenerative cycle using a piston that simultaneously reciprocates and rotates in a cylinder to change the volume of chambers in response to reciprocation and to provide control valve functions in response to rotation. The device on FIG. 12 is is disclosed in U.S. Pat. No. 1,275,507.

### SUMMARY OF THE INVENTION

The present invention is directed at addressing the above-mentioned problems of the prior art. The object of this invention is to improve the performance of the said heat machines using regenerative gas cycle (e.g. Stirling cycle, Ericsson cycle, Vuilleumier cycle, Gifford McMahon cycle, Sibling cycle and similar).

In accordance with the present invention the energy conversion device includes at least two displacer units, at least one counterflow heat exchanger, at least one work machine, a controlling device and connecting conduits. Each displacer unit has an internal chamber with displacer elements dividing the chamber into enclosed zones: hot zone and cold zone, operating mechanism for moving displacers, actuating medium which can be gas or liquid. An actuating medium is able to flow back and forth between the two enclosed zones through the connecting counterflow hat exchanger and conduits. The said hot and cold zones may have internal and external heat exchanging surfaces of different types, such as flat surface, fins. The counterflow heat exchanger is comprised of two identical heat exchanging channels that enable countercurrent gas flow, and separation wall that physically isolates channels but, at the same time, enables heat exchange between countercurrent flowing of fluid and heat carrier within these channels. Each channel of the said counterflow heat exchanger is connected by conduits with each displacer unit. Displacing elements can be, for example, a piston-displacer, a fan of any type, a pump of any type or any other device capable of displacing the actuating medium. The motion of the displacing elements is performed by operating mechanism (external drive) actuated by the controlling device. The controlling device can be kinematical mechanism of different construction or process managing unit with drives and actuating devices (mechanical, electrical, hydraulic or pneumatic etc.). Additional valves and conduits can be introduced for the improving device regenerative cycle and redirecting the flow of actuating mediums. The work machine has at least one input/output for receiving or transmitting pressure variations of actuating medium. When the present invention is implemented as a heat engine configuration at least one heat source should be added and at least one work machine should be equipped with at least one input, capable of receiving and converting pressure variations into effective work. When the present invention is implemented as a heat pump configuration the work machine should be capable of generating pressure variations and be equipped with at least one output, enabling the transmission of said pressure variations.

One embodiment discloses a an energy conversion device providing a method of preserving and regenerating heat energy. A first displacing unit is connected to a heat source on one end and on the other end connected to a reservoir, said unit has an actuating medium, which flows back and forth between two enclosed zones. This actuating medium will be referred further on as fluid (e.g. hydrogen, helium, nitrogen, air). Equivalently the second displacing unit functions as a heat accumulator. The actuating medium which flows back and forth between heat accumulator's enclosed zones will be referred to as heat carrier (e.g. gas or liquid). The first displacing unit has the internal and external heat exchanging surfaces. The heat accumulating device may be constructed in the same way as a first displacer unit, but with no external dissipation or utilization of thermal energy. According to this embodiment, the displacer is thermally coupled to a heat accumulating device (heat accumulator) through the counterflow heat exchanger, wherein the displacing unit and the heat accumulator cycles have opposite heat regenerative phases.

The heat energy exchange is performed in the counterflow heat exchanger between fluid and heat carrier during concurrent and countercurrent flow of the said actuating mediums.

A combination of several displacer units with a heat accumulating device is also possible. Such combination is enabled on condition that the proper operation of the each heat exchanger, coupling two displacing units-each displacer unit and the heat accumulator, is preserved. The process should be particularly implemented with the optimized amount of heat transferring in both channels of a heat exchanger and recuperating with minimal losses.

The method of storing and regenerating of heat energy is implemented within an energy conversion device comprising of displacer unit thermally coupled through the counterflow heat exchanger with heat accumulator. The flow of said heat carrier is synchronized with the flow of said fluid; both mediums are forced to flow concurrently through the thermally coupled channels of counterflow heat exchanger.

The configuration of the current embodiment of energy conversion device demands the assembly of at least one heat source; the equipping of work machine with at least one input capable of receiving pressure variations generated by the displacer unit. This way, the regenerative cycle of the energy conversion device operating as a heat engine can be characterized by the following successive main phases:

At the first phase of the cycle the fluid is enclosed in the hot zone of the displacer unit, is being expanded, thereby high pressure is being received at the work machine input and is being converted into the net work. Simultaneously the heat carrier is enclosed in the cold zone of the heat accumulator, preserving low thermal energy for the determined time interval.

At the next phase the fluid is moving to the cold zone through the heat exchanger, part of the fluid heat energy is transferred to the heat carrier, which moves in the opposite direction through the thermally coupled channel of the said heat exchanger. Thus the temperature of the fluid flowing into the cold zone is almost at the temperature of the stored heat carrier at the previous phase. Synchronously the heat carrier is being moved to the hot zone through the heat exchanger, the heat energy of the fluid is being absorbed by the heat carrier, which is being moved in the opposite direction through the thermally coupled channel of the said heat exchanger. Thus the temperature of the heat carrier flowing into its hot zone is almost at the temperature of the previously fluid coming from its hot zone.

At the next phase of the cycle the fluid is enclosed in the cold zone of the displacer unit is being cooled and compressed, thereby low pressure is being received at the work machine input. Simultaneously the heat carrier is enclosed in the hot zone of the heat accumulator, preserving high thermal energy for the determined time interval

At the next phase the fluid is moving to its hot zone through the heat exchanger absorbing the preserved high thermal energy (of previously phase) from the heat carrier which is being moved in the opposite direction through the thermally coupled channel of the said heat exchanger. Thus the temperature of the fluid flowing into its hot zone is almost at the temperature of the stored heat carrier of the previous stage. Synchronously the heat carrier is being moved to its cold zone through the heat exchanger, wherein the heat energy is transferred to the fluid, which is being moved in the opposite direction through the thermally coupled channel of the said heat exchanger. Thus the temperature of the heat carrier flowing into its cold zone is almost at the temperature of the fluid in its cold zone in the previous phase.

The configuration of the current embodiment of energy conversion device demands the assembly of the work machine equipped with at least one output, capable of transmitting pressure variations generated by the said work machine. This way, the regenerative cycle of the energy conversion device operating as a heat pump, can be characterized by the following successive main phases:

At the first phase of the cycle the fluid enclosed in the hot zone of the displacer unit, is being compressed as result of the high pressure transmitted from the output of the work machine, thereby said fluid is heated and the heat energy is delivered to the hot zone of the heat exchanger surface of the displacer unit. Simultaneously the heat carrier is enclosed in the cold zone of the heat accumulator, preserving low thermal energy for the determined time interval.

At the next phase the fluid is moving to the cold zone through the heat exchanger, part of the fluid heat energy is transferred to the heat carrier, which moves in the opposite direction through the thermally coupled channel of the said heat exchanger. Thus the temperature of the fluid flowing into its cold zone is almost at the temperature of the stored heat carrier at the previous phase. Synchronously the heat carrier is being moved to the hot zone through the heat exchanger, the heat energy of the fluid is being absorbed by the heat carrier, which is being moved in the opposite direction through the thermally coupled channel of the said heat exchanger. Thus the temperature of the heat carrier flowing into its hot zone is almost at the temperature of the previously fluid coming from its hot zone.

At the next phase of the cycle the fluid enclosed in the cold zone of the displacer unit, is being expanded as result of the low pressure transmitted from the outlet of the work machine, thereby said fluid is being cooled and absorbing heat energy from the heat exchanger surface of the cold zone. Simultaneously the heat carrier is enclosed in the hot zone of the heat accumulator preserving high thermal energy for the determined time interval.

At the next phase the fluid is moving to the hot zone through the heat exchanger absorbing the preserved high thermal energy (of previously phase) from the heat carrier which is being moved in the opposite direction through the thermally coupled channel of the said heat exchanger. Thus the temperature of the fluid flowing into the hot zone is almost at the temperature of the stored heat carrier of the previous stage. Synchronously the heat carrier is being moved to the cold zone through the heat exchanger, wherein the heat energy is transferred to the fluid, which is being moved in the opposite direction through the thermally coupled channel of the said heat exchanger. Thus the temperature of the heat carrier flowing into its cold zone is almost at the temperature of the fluid in its cold zone in the previous phase.

A further embodiment of the present invention discloses a method of preserving and regenerating heat energy, and an energy conversion device utilizing this method. This can be done by replacing conventional regenerators of coupled heat machines by counterflow heat exchanger and combining at least two heat machines in one by the way of arranging their cycles with opposite regenerative phases. Furthermore, coupling of unidentical heat machines is also possible, on condition that the proper operation of the counterflow heat exchanger is preserved-particularly the optimal amount of the heat is transferred and recuperated with minimal losses in both channels of the said counterflow heat exchanger.

An actuating medium of heat machine, which flows back and forth between two enclosed zones of displacer units, will be referred further on as fluid (e.g. hydrogen, helium, nitrogen, air). Heat machine has the internal and external heat exchanging means (heat exchange surface). According to this embodiment both displacer units are thermally coupled wherein coupled displacer units have cycle with opposite heat regenerative phases. Additional valves can be introduced for the improving device according to this invention and redirecting the flow of fluid. Furthermore an optional implementation of said displacer unit integrates the operation of a work machine; therefore there is no need for standalone work machine unit. In this instance, implementing kinematical mechanism as controlling device, is more advantageous, than actuating device with process manager unit.

The method of storing and regenerating of heat energy is implemented within an energy conversion device comprising of two displacer unit thermally coupled through the counterflow heat exchanger. The regenerative cycle for one displacer unit can be identical and synchronous but different in phase for other coupled machine.

To release effective work, the variations of fluid pressure are guided to a work machine when the fluid is being expanded and being compressed in their associated zones. The configuration of the current embodiment of energy conversion device demands to assemble at least one heat source, to equip work machine with at least two inputs capable to receive pressure variations generated by the displacer units.

The regenerative cycle of the energy conversion device can be characterized by the following successive main phases:

The fluid enclosed in the hot zone of the first displacer unit, is being heated and expanded, thereby high pressure is received at the first work machine input. Simultaneously the fluid is enclosed in the cold zone of the second displacer unit, is being cooled and compressed, thereby low pressure is received at the second work machine input.

After the process of expansion, the fluid of the first displacer unit is being moved to the cold zone through the counterflow heat exchanger, transferring almost all of its heat energy to the fluid (of the coupled machine) being moved in the opposite direction through the thermally coupled channel of the said counterflow heat exchanger. Thus the fluid flowing into the cold zone is almost at the temperature of the previously cooled fluid of the coupled displacer unit.

The fluid enclosed in the cold zone of the first displacer unit, is being cooled and compressed, thereby low pressure is received at the first work machine input. Simultaneously the fluid enclosed in the hot zone of the second displacer unit, is being heated and expanded, thereby high pressure is received at the second work machine input.

After the process of compression the fluid of the first displacer unit is moved to its hot zone, through the counterflow heat exchanger, absorbing almost all of the heat energy of the second displacer unit fluid moving in the opposite direction through the thermally coupled channel of the said heat exchanger. Thus the fluid flowing into the hot zone is almost at the temperature of the previously heated fluid of the coupled displacer unit.

Third implementation (FIG. 3): method of converting and regenerating energy, and a heat pump utilizing this method.

To obtain temperature gradient, transfer of the heat is provided from the heat exchange surface of the cold zone to the heat exchange surface of the hot zone of a displacer unit. Work machine generates and transmits from its at least two outputs the variations of fluid pressure, thereby the fluid is being compressed and heated when affected from low to higher pressure and expanded and cooled when affected from high to lower pressure. The configuration of the current embodiment of energy conversion device demands to assemble the work machine equipped with at least two outputs capable to transmit pressure variations generated by work machines, then the regenerative cycle of the energy conversion device operating as a heat pump can be characterized by the following successive main phases.

The fluid enclosed in the hot zone of the first displacer unit is being compressed as result of the high pressure transmitted from the first output of the work machine, thereby said fluid is being heated and the heat energy is delivered to the hot zone of the heat exchange surface of the first displacer unit. Simultaneously the fluid enclosed in the cold zone of the second displacer unit is expanding as result of low pressure transmitted from the second output of the work machine, thereby said fluid is being cooled and absorbing heat energy from the cold zone heat exchange surface of the second displacer unit.

After the process of compression, the fluid of the first displacer unit is being moved to the cold zone through the counterflow heat exchanger, transferring almost all of its heat energy to the fluid (of the coupled machine) being moved in the opposite direction through the thermally coupled channel of the said counterflow heat exchanger. Thus the fluid flowing into the cold zone is almost at the temperature of the previously cooled fluid of the coupled displacer unit.

The fluid enclosed in the cold zone of the first displacer unit is expanding as result of the low pressure transmitted from the first output of the work machine, thereby said fluid is cooled and the heat energy is absorbed from the cold zone of the heat exchanger surface of the first displacer unit. Simultaneously the fluid enclosed in the hot zone of the second displacer unit is being compressed as result of high pressure transmitted from the second output of the work machine, thereby said fluid is being heated, delivering heat energy to the hot zone heat exchange surface of the second displacer unit.

After the process of expansion the fluid of the first displacer unit is moved to its hot zone, through the counterflow heat exchanger, absorbing almost all of the heat energy of the second displacer unit fluid moving in the opposite direction through the thermally coupled channel of the said heat exchanger. Thus the fluid flowing into the hot zone is almost at the temperature of the previously heated fluid of the coupled displacer unit.

For the improved operation of the presented heat machine, the motion of displacers should be stick-slip from the one extreme position to another. Moreover the combined heat machines can be of different useful capacity and different purposes. For instance one heat machine can be used for temporary storage of the heat energy for one device or several devices combined with the said heat machine; or can be the heat receiver of another device or several devices. Therefore, when combined with more than one device, the heat capacity of the fluid should be enough to supply the heat to its combined devices; the motion of the piston when operating in the regenerative phase with one of the combined devices is preformed incrementally from one extreme position to another within the determined step. The heat capacity of fluid displaced by one step should be equal to the heat capacity of countercurrent flow of fluid of another heat machine through the counterflow heat exchanger.

The duration of holding the displacer in the hot zone have to be controlled due to the wide-range adjustment of output power, mostly when the invented heat machine operates as a heat engine.

In as much as the invented heat machine is symmetrical, then the disorder of symmetric operation of this displacer unit leads to disorder of the symmetry of work of the counterflow heat exchanger. The problem is solved by increasing the mass of the heat exchanger. In another words, the increasing of the mass of the walls separating counterflow heat exchanger's channels, (and therefore increasing its heat capacity), provide the properties of a regenerator (working as a heat accumulator). Therefore, the heat could be effectively recovered to the hot zone as in said symmetrical cycles.

To improve the compactness of the invented device it is useful to obtain the reduction of total length of the counterflow heat exchanger. Therefore it should be crafted with a material of specific heat conductance anisotropy of walls of separating channels of heat conductance to achieve less thermal resistance across the walls of separating channels of opposite fluid flows than the thermal resistance along the walls of separating channels of opposite fluid flows.

Fourth implementations (FIG. 23) include two displacer units and one accumulator, to enable power adjustment.

For enabling continuous control of the output power of the energy conversion device which is comprised of two combined heat machines, is suggested to implement a method of intermediate storage and regeneration of heat energy. Therefore, for this purpose, the heat accumulator is designed with enough heat capacity enabling to store the heat energy generated by the displacer units. A certain amount of almost all heat energy of the fluid of the first displacer unit, is transferred through the first counterflow heat exchanger to the heat carrier of the heat accumulator, which is preserved there for certain controllable time, and then transferred to the fluid of the second displacer unit, through the second counterflow heat exchanger. The process of the heat energy transfer is then performed symmetrically from the second displacer unit to the first displacer unit.

The device in accordance with further implementation of the present invention includes at least two displacer units (two displacing units), at least two counterflow heat exchangers, heat accumulator (one displacing unit), a controlling device, at least one work machine, valves for redirection of actuating medium and connecting conduits. Heat exchanger is inserted between each displacer unit and heat accumulator. Thereby each displacer unit is thermally coupled with the heat accumulator through respective counterflow heat exchanger.

Valves are installed in conduits to enable the redirection of the heat carrier to the corresponding acting heat exchanger. Additional valves can be further implemented for improving the fluid flows within regenerative cycle of energy conversion device.

When the device is in heat engine configuration, pressure variations of fluid are generated by displacer units, work machine receives and converts variations of pressure into efficient work. When the device is in heat pump configuration pressure variations of fluid are generated by work machine actuated by some external source of energy, thereby variations of fluid pressure are transmitted to displacer units. The controlling device manages valves and displacer means to provide the proper flow of heat carrier and fluids through counterflow heat exchangers according to a predefined scenario which includes phases of the above-stated method.

The regenerative cycle for the energy conversion device can be characterized by the following main phases.

The fluid of the first displacer unit is enclosed in its hot zone. The heat carrier is enclosed in the cold zone of the heat accumulator, preserving low thermal energy for the determined time interval.

The fluid of the first displacer unit is moving to its cold zone through the first heat exchanger transferring the hot zone fluid heat energy to the heat carrier moving in the opposite direction through the thermally coupled channel of the first heat exchanger. Thus the fluid of the first displacer unit flowing into its cold zone is almost at the temperature of the previously stored heat carrier. Synchronously the heat carrier is moving to its hot zone through the first heat exchanger absorbing the heat energy of the fluid of the first displacer unit moving in the opposite direction through the thermally coupled channel of the first heat exchanger. Thus the heat carrier flowing into its hot zone is almost at the temperature of the previous fluid from its hot zone. The flow of the fluid of the second displacer unit is blocked while the flows of actuating medium through the second heat exchanger are blocked by valves.

The fluid of the first displacer unit is enclosed in its cold zone. The heat carrier is enclosed in the hot zone of the heat accumulator, preserving high thermal energy for the determined time interval.

The fluid of the first displacer unit is moving to its hot zone through the first heat exchanger absorbing the previously stored high thermal energy from the heat carrier moving in the opposite direction through the thermally coupled channel of the first heat exchanger. Thus the fluid of the first displacer unit flowing into the hot zone is almost at the temperature of the previously stored heat carrier. Synchronously the heat carrier is moving to its cold zone through the first heat exchanger transferring the heat energy to the fluid moving in the opposite direction through the thermally coupled channel of the first heat exchanger. Thus the heat carrier flowing into its cold zone is almost at the temperature of the previous fluid of the first displacer unit from its cold zone. The flow of fluid of the second displacer unit is withheld and flows of actuating medium through the second heat exchanger are blocked by valves.

The fluid of the second displacer unit is enclosed in its hot zone. The heat carrier is enclosed in the cold zone of the heat accumulator, preserving low thermal energy for the determined time interval.

The fluid of the second displacer unit is moving to its cold zone through the second heat exchanger transferring the hot zone fluid heat energy to the heat carrier moving in the opposite direction through the thermally coupled channel of the first heat exchanger. Thus the fluid of the second displacer unit flowing into its cold zone is almost at the temperature of the previously stored heat carrier. Synchronously the heat carrier is moving to its hot zone through the second heat exchanger absorbing the heat energy of the fluid of the second displacer unit moving in the opposite direction through the thermally coupled channel of the said heat exchanger. Thus the heat carrier flowing into its hot zone is almost at the temperature of the previous fluid of the second displacer unit from its hot zone. The flow of fluid of the first displacer unit is withheld and flows of actuating medium through the first heat exchanger are blocked by valves.

The fluid of the second displacer unit is enclosed in its cold zone. The heat carrier is enclosed in the hot zone of the heat accumulator, preserving high thermal energy for the determined time interval.

The fluid of the second displacer unit is moving to its hot zone through the second heat exchanger absorbing the previously stored high thermal energy from the heat carrier moving in the opposite direction through the thermally coupled channel of the second heat exchanger. Thus the fluid of the second displacer unit flowing into the hot zone is almost at the temperature of the previously stored heat carrier. Synchronously the heat carrier is moving to the cold zone through the second heat exchanger transferring the heat energy to the fluid moving in the opposite direction through the thermally coupled channel of the second heat exchanger. Thus the heat carrier flowing into its cold zone is almost at the temperature of the previous fluid of the second displacer unit from its cold zone. The flow of fluid of the first displacer unit is blocked while the flows of actuating medium through the first heat exchanger are blocked by valves.

Using the device of FIG. 23 two different heat machines can be combined in accordance with the same method.

The presented method enables to combine heat machines even with different heat capacity of fluids and different working volumes. Then the heat capacity of the heat carrier should be less or equal to the largest heat capacity of the fluid contained within one of the heat machines. The potion of the heat carrier flowing through the heat exchangers should be adjusted in order to prevent thermal energy losses. Therefore, the step of the moving the displacing element of the heat accumulator should be adjusted respectively.

The device as illustrated in FIG. 23 further includes a device for controlling and synchronizing the motion of the displacer unit's and heat accumulator's displacing elements.

Advantages

The advantage of the present invention is that the heat energy, stored in the said heat accumulator, can be much better isolated from the working volume of the heat machine than in the conventional regenerators, consequently increasing the efficiency of the heat machine. Moreover the duration of heat storage within the heat accumulator, can be longer than in said regenerator.

A further advantage of the present invention is that it enables adjustment of the output power for two combined heat machines when their opposite regenerative phases are not concurrent or there is a time delay between said phases, thereby storing the heat energy for some short-duration phase of regenerative cycle.

A further advantage of the present invention is that the counterflow heat exchanger can be introduced as a regenerator with an unlimited heat capacity. Replacing both regenerators with a single, more efficient counterflow heat exchanger, allows total heat machine efficiency improvement by the same ratio. Moreover, regenerator's heat capacity is limited and constituted by its material and geometrical structures. Increasing heat machine's working volume size, might lead to a total efficiency reduction, if the heat that must be captured during said cycle is higher than the maximum regenerator heat capacity. Unlike regenerators, counterflow heat exchanger's heat capacity is unlimited. Therefore, replacing regenerators with a single counterflow heat exchanger, allows the increasing of total heat machine's working volume, consequently, improving working volume to dead volume ratio.

A further advantage of the present invention is that the counterflow heat exchanger can be crafted with less gas-dynamic drag and less dead volume than conventional regenerator; that is additionally increases the efficiency of operation of the invented device.

A further advantage of the present invention is that the dissipated power is dramatically decreased and this allows downsizing cooler means and simplifying construction.

Another advantage of the present invention is that the embodiment of two identical heat machines into double acting uniform mechanism improves overall bulk properties of machine.

Another advantage of the present invention is that the efficiency of the invented heat machine is almost stable at any level of power.

Another advantage of the present invention is that the invented heat machine can be quickly stopped and launched again with minimum latency within these two processes.

Various additional advantages and features of novelty which characterize the invention are further pointed out in the claims that follow. However, for a better understanding of the invention and its advantages, reference should be made to the accompanying drawings and descriptive matter which illustrate and describe preferred embodiments of the invention.

### BRIEF DESCRIPTION OF THE DRAWINGS

These and further features and advantages of the invention will become more clearly understood in the light of the ensuing description of a few preferred embodiments thereof, given by way of example only, with reference to the accompanying drawings (FIGS.), wherein.

FIG. 1 is a flow chart of heat sharing in the Carnot cycle versus heat regenerative gas cycle.

FIG. 2 is a prime mover schematic view to the invented energy conversion device. The regenerator of the heat machine is replaced by counterflow heat exchanger and heat accumulator.

FIG. 3 is a prime mover schematic view to the invented energy conversion device.

FIG. 4 is a schematic drawing of an alternative version to the invented energy conversion device.

FIG. 5 is a schematic drawing of an alternative version to the invented energy conversion device.

FIG. 6 is a schematic drawing of prior art of Stirling cycle engine/heat pump

FIG. 7 is a schematic drawing of the energy conversion device comprised of combination of regenerative Stirling cycle engine/heat pumps according to the invention.

FIG. 8 is a schematic drawing of prior art of Gifford cycle heat pump

FIG. 9 is a schematic drawing of the energy conversion device comprised of combination of improved regenerative Gifford cycle heat pumps according to the invention.

FIG. 10 is a schematic drawing of prior art of Vuilleumier cycle energy conversion device.

FIG. 11 represents a schematic drawing of the energy conversion device comprised of combination of improved Vuilleumier cycle energy conversion devices according to the invention.

FIG. 12 represents a schematic drawing of prior art of Sibling cycle energy conversion device.

FIG. 13 represents a schematic drawing of the energy conversion device comprised of combination of improved Sibling cycle energy conversion devices according to the invention.

FIG. 14 is modified schematic view to the invented energy conversion device in engine configuration.

FIG. 15 is a schematic view of the energy conversion device during stage A.

FIG. 16 is a schematic view of the energy conversion device during stage B.

FIG. 17 is a schematic view of the energy conversion device during stage C.

FIG. 18 is a schematic view of the energy conversion device during stage D.

FIG. 19 is a schematic view of the energy conversion device during stage E.

FIG. 20 is a schematic view of the energy conversion device during stage F.

FIG. 21 is a schematic view of a suggested application to the energy conversion device. In this drawing a combustion assembly is coupled to the energy conversion device.

FIG. 22 is a schematic drawing of a suggested application to the energy conversion device. In this drawing pressure tanks are added between energy conversion device and work machine.

FIG. 23 is a schematic drawing of energy conversion device with the improved adjustment of power output. Heat machines are coupled with heat accumulator through the counterflow heat exchanger.

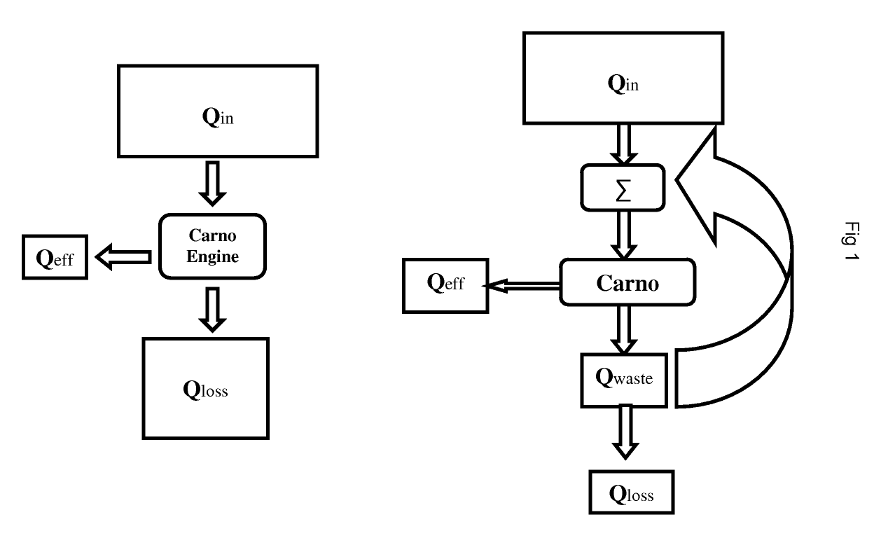

### DETAILED DESCRIPTION OF THE INVENTION

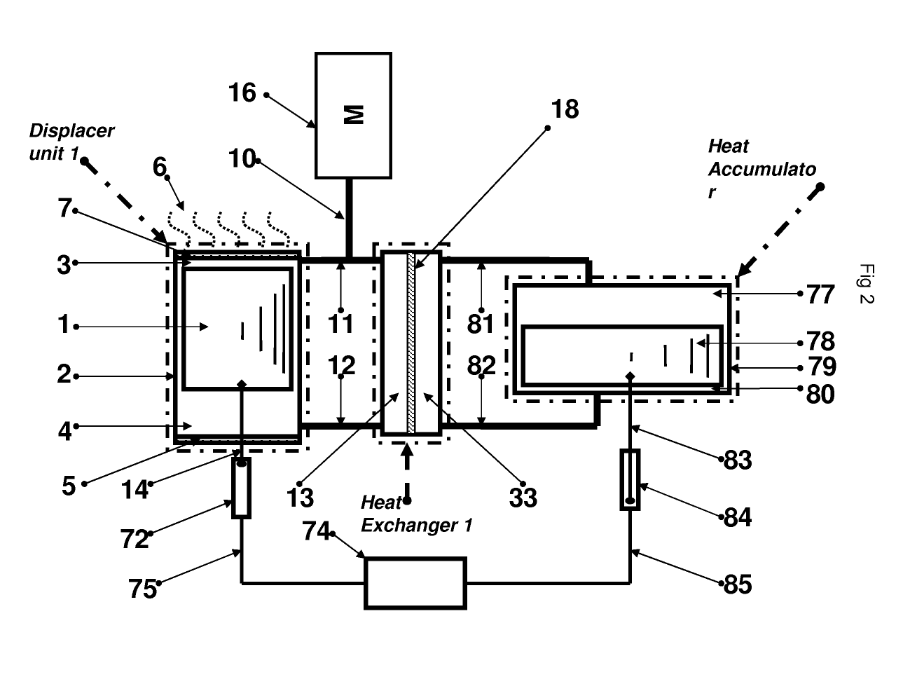

Referring first to FIG. 2, is illustrated an energy conversion device that can operate both as an engine or a heat pump according to one embodiment of this invention. The energy conversion device is comprised of two displacer units (Heat Machine 1, Heat Accumulator), a counterflow heat exchanger and a work machine (16) that is capable of receiving/transmitting variations of pressure.

Each displacer unit is comprised of a displacer chamber (2, 79), displacer (1, 78), a hot zone (3, 77), a cold zone (4, 80) and an actuating drives (14, 83) to drive the displacers by the commands of the external control unit. Displacer chamber of Heat Machine 1 further includes two heat exchangers: the first heat exchanger surface (7) which enables heat exchange of the high temperature heat energy between the heat source (6) and the hot zone (3) and a second heat exchange surface (5) which enables heat exchange of the low temperature heat energy between the cold zone (4) and the reservoir. Actuating devices (72, 84) are controlled by the process manager unit (74) with control drives (75, 85). The counterflow heat exchanger (Heat Exchanger 1) is comprised of two identical heat exchanging elements—channels (13, 33), that enable countercurrent gas flow, and separation wall (18) that physically isolates channels but enables heat exchange between countercurrent flowing of fluid and heat carrier within these channels.

The heat machine's hot zone (3) is attached to the work machine (16) through a conduit formed by pipes (11, 10). The hot zone (3) is also connected to the counterflow heat exchanger channel (13) through part of the conduit formed by the pipe, (11) allowing gas flow in both directions. The cold zone (4) is connected to the counterflow heat exchanger channels (13) as well, through the conduit (12) allowing gas flow in both directions.

The heat accumulator's hot (77) and cold (80) zones are part of the chamber (79) volume. The chamber's functionality is directed at storing the heat carrier charged by thermal energy during regenerative cycle. The heat accumulator's hot zone (77) is connected to the counterflow heat exchanger channel (13) through conduit (81) allowing gas flow in both directions. The heat accumulator's cold zone (80) is connected to the counterflow heat exchanger channel (33) as well, through conduit (82) allowing gas flow in both directions.

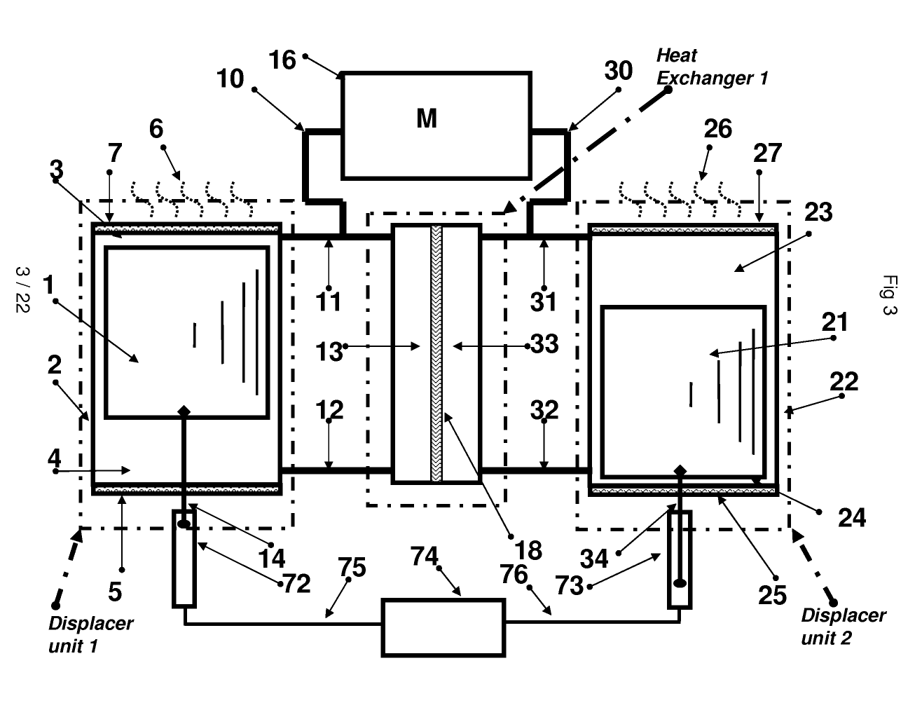

Referring first to FIG. 3 another variation of energy conversion device that can operate both as an engine or heat pump according to one embodiment of this invention is shown. The energy conversion device is comprised of two displacer units (Heat Machine 1, Heat Machine 2), a counterflow heat exchanger (Heat Exchanger 1) and a work machine (16) that is capable of receiving/transmitting variations of pressure.

Each displacer unit is comprised of: a displacer chamber (2, 22); a displacer (1,21); a heat exchange surface (7, 27), which exchanges high temperature heat between the heat source (6, 26) and the fluid in the hot zone (3, 23); heat exchange mean (5, 25) which exchange low temperature heat between the fluid in the cold zone (4, 24) and the reservoir; actuating drives (14, 34) that drives the displacers by the controlling device's commands. The actuating devices (72, 73) are controlled by the process manager unit (74) with the control drives (75, 76). The counterflow heat exchanger is comprised of two identical heat exchanging elements: channels (13, 33), that enable countercurrent gas flow and separation wall (18) that physically isolates channels but, at the same time, enables heat exchange between countercurrent flowing of fluids within these channels.

Each displacer unit is connected to the work machine (16), which can receive or transmit gas pressure variations, and to a counterflow heat exchanger (Heat Exchanger 1), through conduit formed by pipes (10, 11 and 30, 31) and through conduit (12 and 32) allowing gas flow along the cycle. The hot zones (3, 23) are attached to the work machine (16) through conduits formed by pipes (11, 10 and 30,31). Hot zones (3, 23) are also connected to the counterflow heat exchanger elements (13, 33) through part of the conduit formed by pipe (11, 31), allowing gas flow in both directions. The cold zones (4, 24) are connected to the counterflow heat exchanger channels (13,33) as well, through other conduits (12,32), allowing gas flow in both directions.

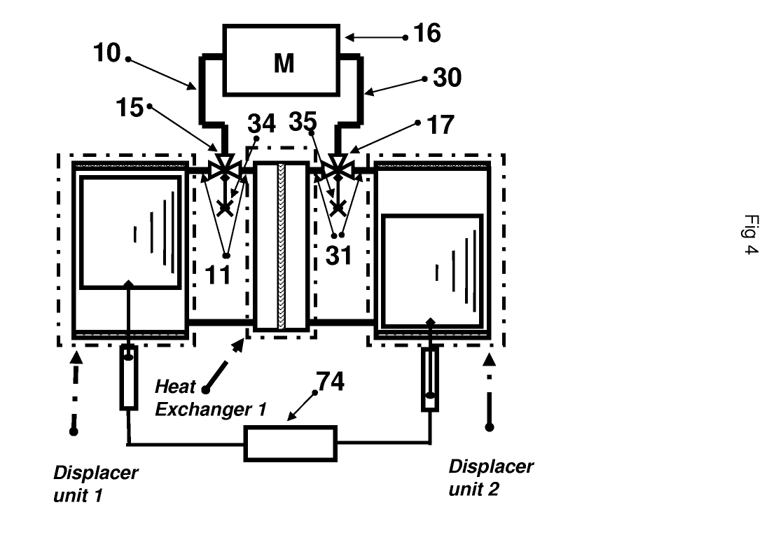

Referring to FIG. 4 another variation of energy conversion device according to one embodiment of this invention is shown. The difference from the previous variation in FIG. 3 is that redirecting valves (15, 17) controlled by drives (34, 35) of control unit (74) are installed in both conduits formed by pipes (11, 10, and 31, 30). The advantage of this scheme is that it enables controlled gas flow between cycles using coordinated valves, therefore improving energy conversion device efficiency and smoothing energy conversion device operation cycles. After hot gas expansion is completed, valves automatically flip, allowing it to flow through the counterflow heat exchanger (Heat Exchanger 1).

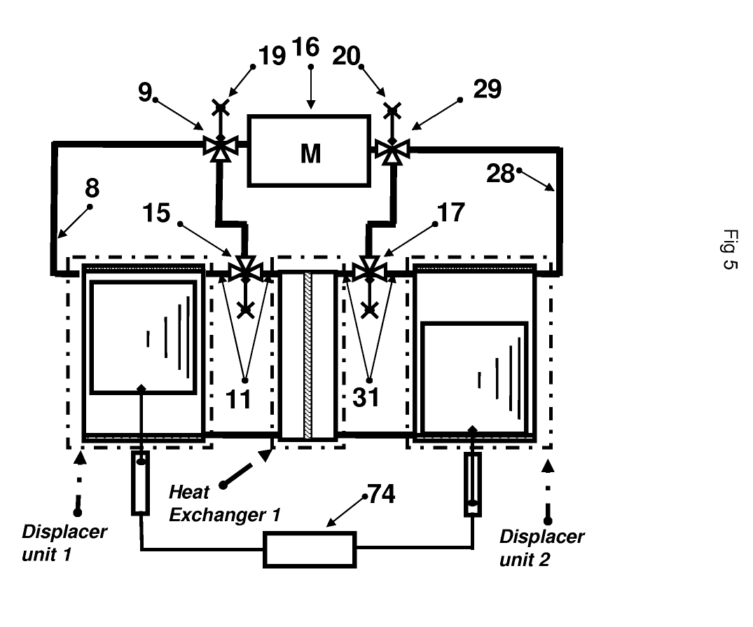

Referring to FIG. 5 another variation of energy conversion device according to one embodiment of this invention is shown. The difference from the previous variation in FIG. 4 is that conduits formed by pipes (8, 28) are added. These pipes connect between from the opposite sides of the hot zone and redirecting valves (9, 29), which in turn are controlled by drives (19, 20) connected to the process manager unit (74). The advantage of this scheme is that it enables fully controlled gas flow through the hot zone, therefore improving the heat exchange within the hot zone. Furthermore, it enables fully controlled gas flow from the work machine (16) to the heat exchanger (Heat Exchanger 1), thus, enhancing the advantage of previous scheme on FIG. 4. This configuration allows fully controllable connections of hot zones, displacer elements and work machine (16) at any given period of time during the cycle.

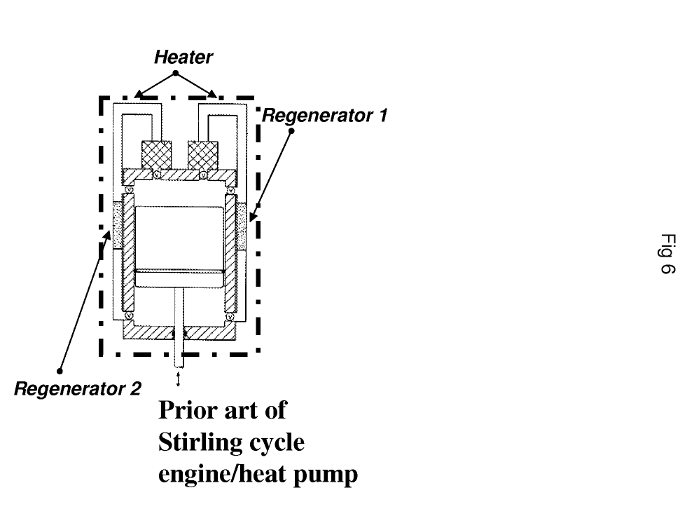

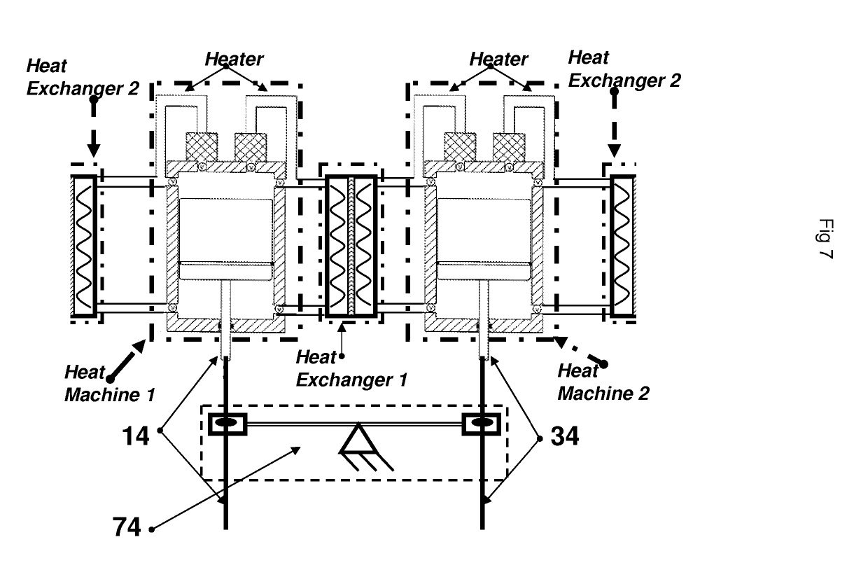

In accordance with further embodiment of the present invention it is suggested to replace the conventional heat machine's regenerator of the heat machine presented on FIG. 6 with a counterflow heat exchanger. Referring to FIG. 7 two devices: (Heat Machine 1, Heat Machine 2) are combined together into one improved unit according to the present invention. The two corresponding pairs (Regenerator 1 pair) and (Regenerator 2 pair) of regenerators are withdrawn from the prior art on FIG. 6 and replaced by two counterflow heat exchangers (Heat Exchanger 1 and Heat Exchanger 2). At this configuration said devices are functioning synchronously and their gas regenerative phases are opposite. The synchronized operation of their double acting pistons is controlled by kinematical mechanism (74) or by an actuating device controlled by a process manager unit. The thermal coupling of these two identical machines is performed through the counterflow heat exchangers, enabling to transfer the rest of the heat energy, when one device is recharging after the stage of gas expansion, thereby, transferring the gas from the hot zone to the cold zone. The heat is than flowing to second device which is now at the stage of gas expansion, thereby displacing the fluid from the cold zone to the heated volume, simultaneously filling the hot zone, expanding from another heated volume. In that part of cycle, the motion of pistons of said devices (Heat Machine 1, Heat Machine 2) are opposite and the flow of fluids are concurrent and countercurrent through the currently acting heat exchanger (Heat Exchanger 1). In this instance presented, displacer units also combine properties of work machine, thereby a mechanical work is obtained by the shafts (14, 34) which are, at the same time, actuating drives of kinematical mechanism (74).

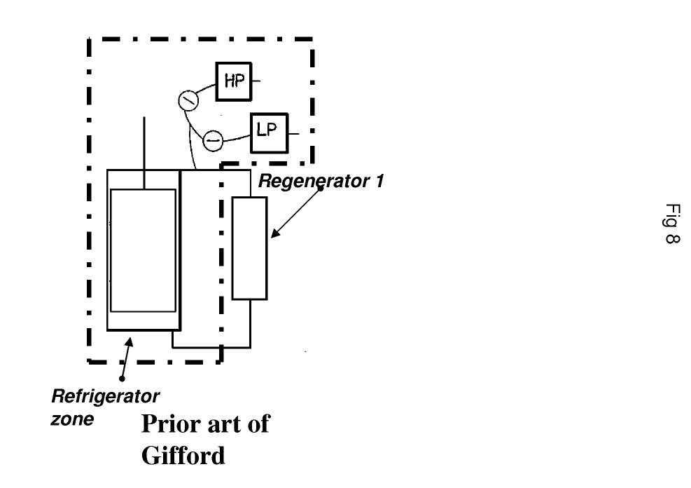

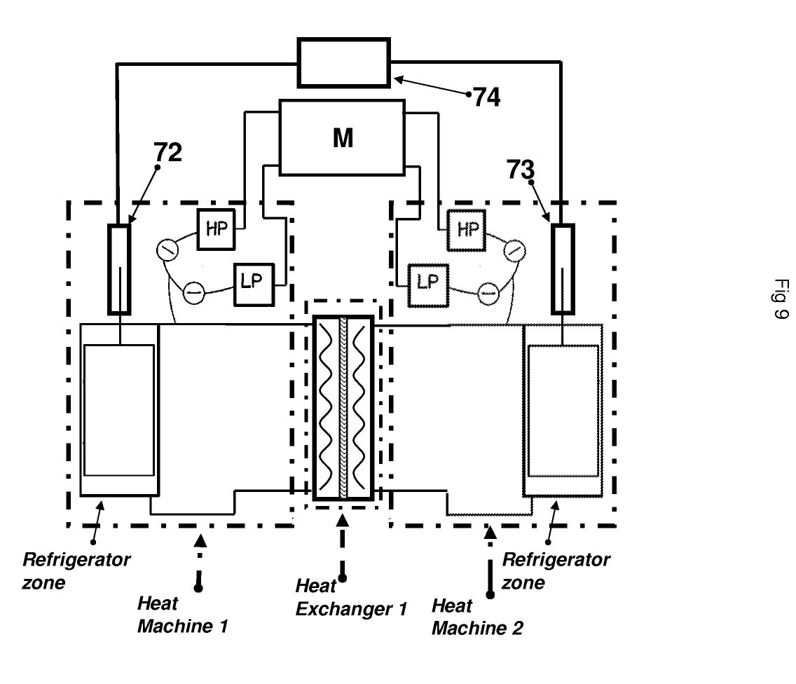

A further embodiment suggests replacing a conventional regenerator of the heat machine on FIG. 8 with the counterflow heat exchanger. Referring to FIG. 9 two Gifford devices are combined together into one improved unit according to the present invention and are relevant to the subject matter of the present invention. Their regenerators (Regenerator 1) are withdrawn from the prior art on FIG. 8 and replaced by one counterflow heat exchanger (Heat Exchanger 1). In this instance both devices (Heat Machine 1, Heat Machine 2) are thermally coupled through the counterflow heat exchanger, functioning synchronously in antiphase of their cycles and the flows of their fluids are concurrent and countercurrent through the said counterflow heat exchanger. The control of the displacing elements of combined units (Heat Machine 1, Heat Machine 2) is performed by the process manager unit (74) and its actuating devices (72, 73). The valve operation of said devices (Heat Machine 1, Heat Machine 2) can also be controlled by the same process manager unit.

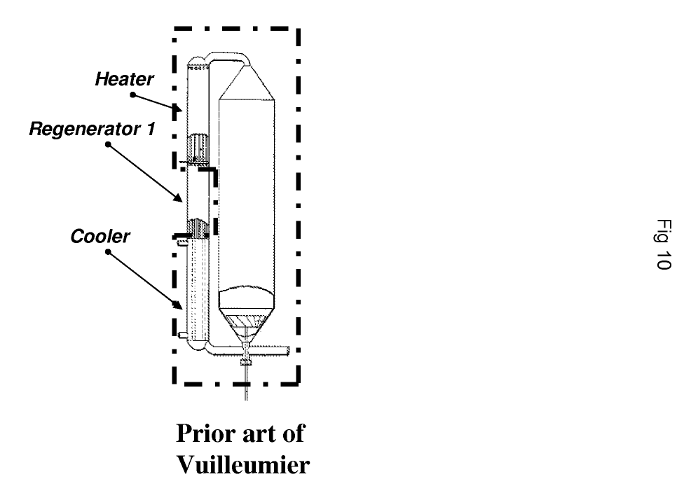

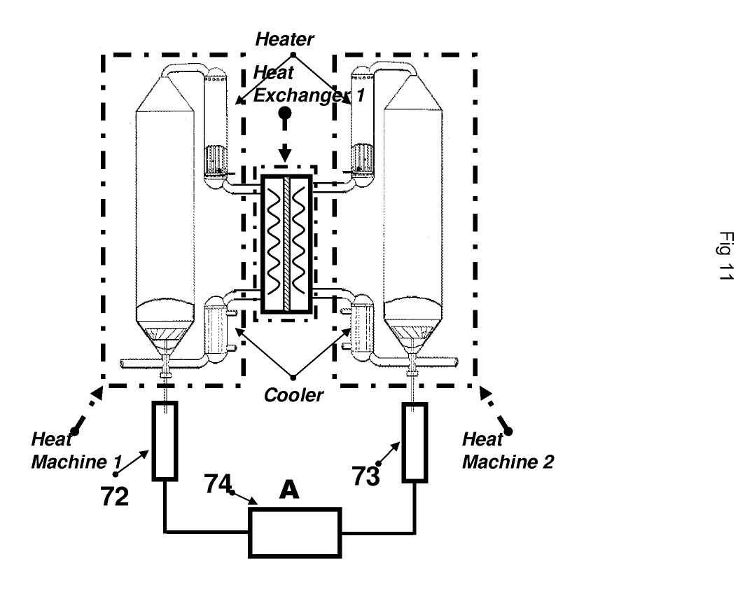

According to further embodiment of the present invention it is suggested replacing a conventional regenerator of the heat machine on FIG. 10 with the counterflow heat exchanger. Referring to FIG. 11 two Vuilleumier devices (Heat Machine 1, Heat Machine 2) are combined together into one improved unit according to the present invention. Their regenerators are withdrawn from the prior art on FIG. 10 and are replaced by one counterflow heat exchanger. In this presented instance both thermally devices are coupled through the counterflow heat exchanger, functioning synchronously in antiphase of their cycles and the flows of their fluids are concurrent and countercurrent through the said counterflow heat exchanger. The control of the displacing elements of combined units (Heat Machine 1, Heat Machine 2) is performed by the process manager unit (74) and its actuating devices (72, 73). Due to the fact that heat exchanger (Heat Exchanger 1) efficiency is higher than regenerator's, cooler means overall dimensions of devices (Heat Machine 1, Heat Machine 2) can be significantly reduced comparing to cooler means designed for prior art in FIG. 10.

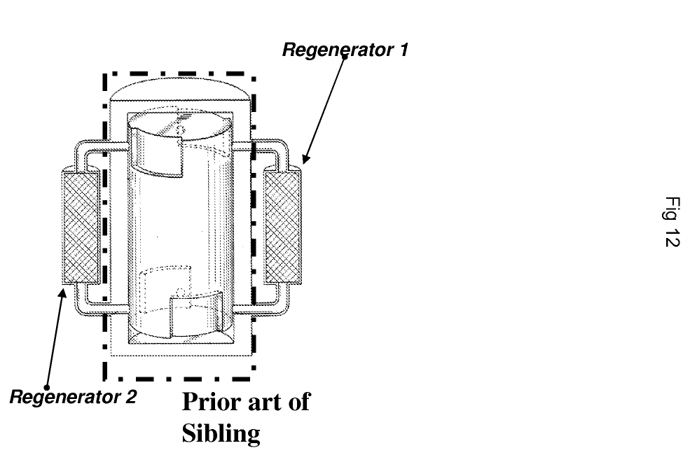

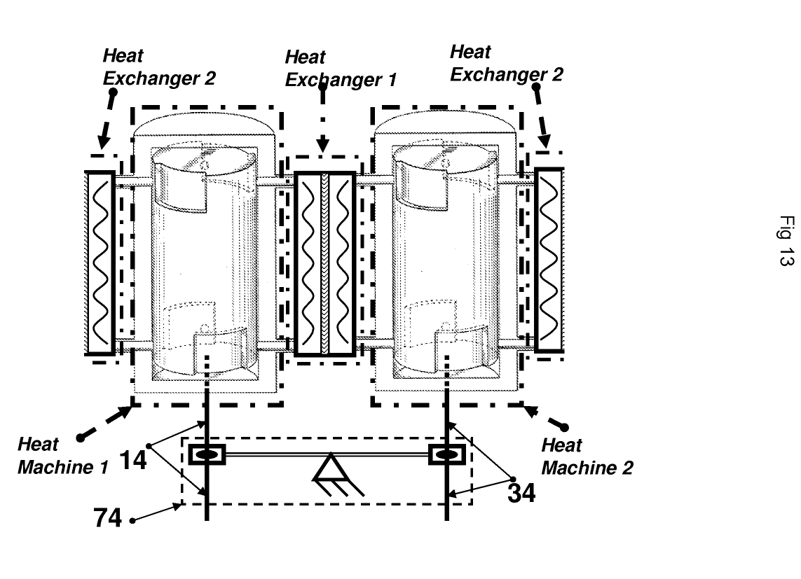

Presenting accordance with further embodiment it is suggests replacing a conventional regenerator of the heat machine on FIG. 12 with the counterflow heat exchanger. Referring to FIG. 13 two devices (Heat Machine 1, Heat Machine 2) are combined together into one improved unit according to the present invention. Their two corresponding pairs (Regenerator 1 pair) and (Regenerator 2 pair) of regenerators are withdrawn from the prior art on FIG. 12 and replaced by two counterflow heat exchangers (Heat Exchanger 1 and Heat Exchanger 2). Said devices are functioning synchronously and their gas regenerative phases are opposite. The synchronized operation of their double acting pistons is controlled by kinematical mechanism (74), or an actuating device controlled by the control unit. The reciprocating motion of pistons of said devices (Heat Machine 1, Heat Machine 2) are opposite and the flows of fluid are concurrent and countercurrent through the currently acting heat exchanger (Heat Exchanger 1). In this presented instance, the piston of the heat machines (Heat Machine 1, Heat Machine 2) integrates the operation of a displacer unit and work machine; thereby the mechanical work is obtained on the shafts (14, 34) which are, at the same time, actuating drives of kinematical mechanism (74).

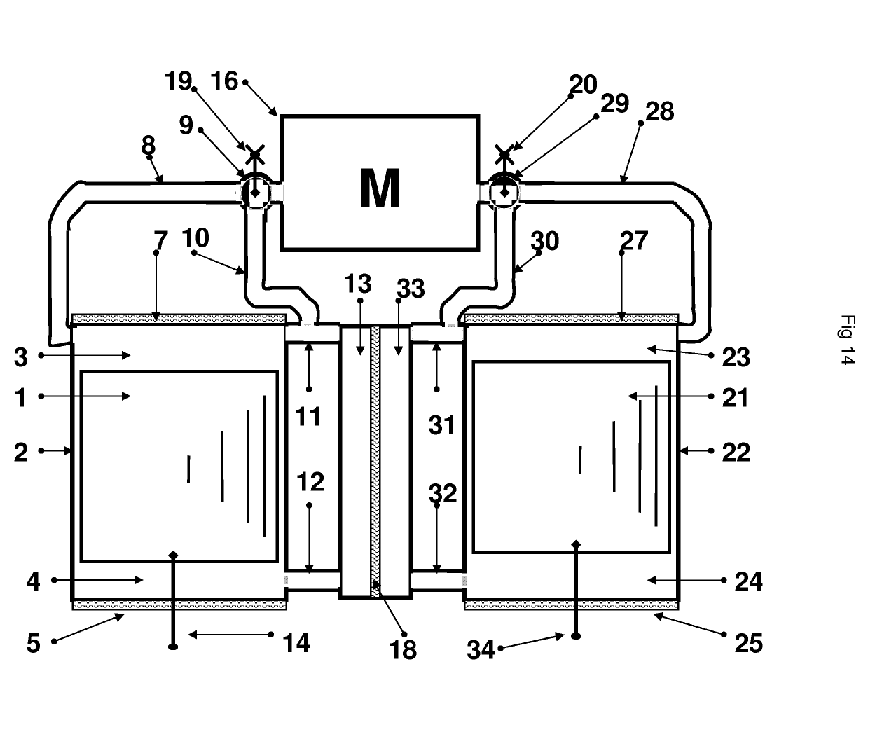

Referring in a more particular way to processes taken place in FIG. 14 as an illustrative example of heat engine are illustrated six different stages of heat engine cycle.

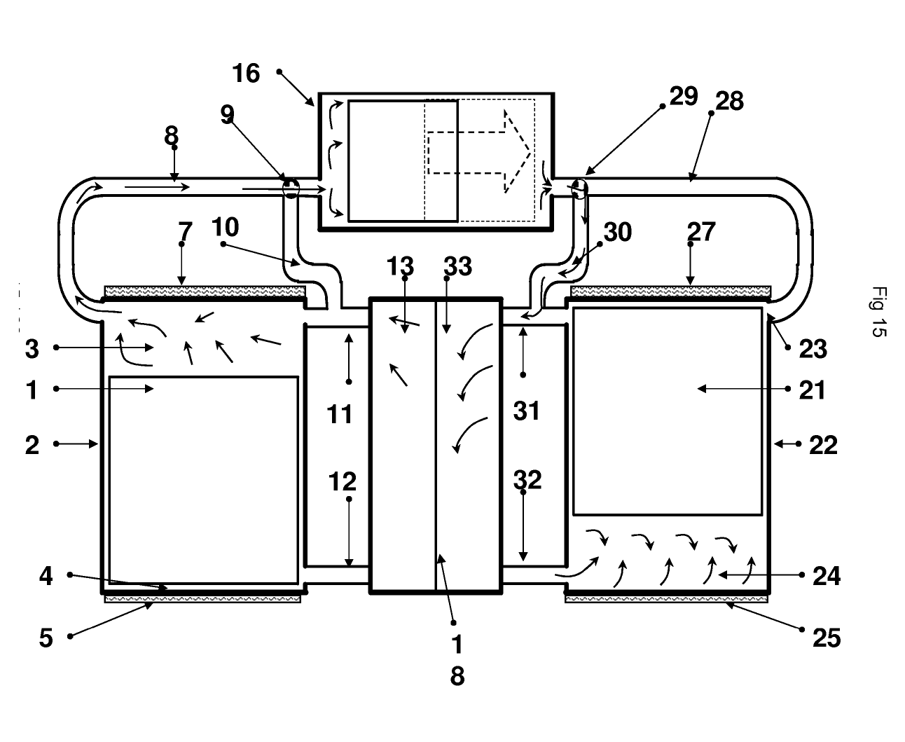

Stage A of the cycle is described in FIG. 15. During this stage, heat exchanger means (7) is being heated by the heat source. Heat is then transferred from the heat exchanger surface to the gas, trapped within the hot zone (3). Heated gas is then expanded, resulting in a pressure incline. Redirecting valve (9) positioned in a horizontal state, allowing expanding gas to develop the high pressure on the left input of work machine (16) actuating the power piston of the work machine (16). Simultaneously the pressure drops from the other side of work machine (16) as result of compressing gas flow through the valve (29), pipe (30), through the counterflow heat exchanger channel (33) to the cold zone (24).

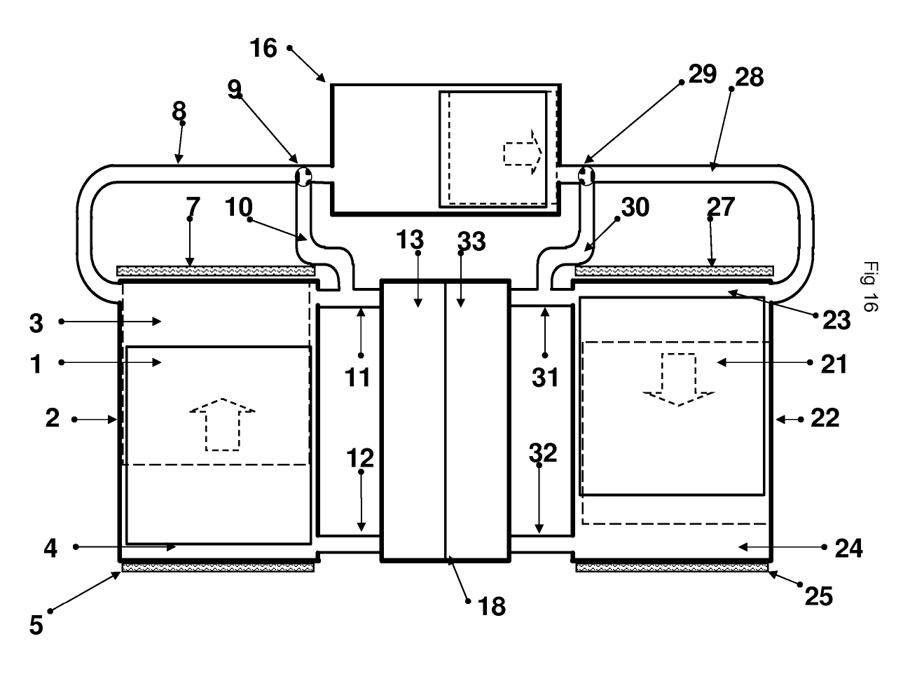

Stage B of the cycle is described in FIG. 16. During this stage, displacer pistons (1, 21), moves to opposite directions, forcing gas to drive through the counterflow heat exchanger channels (13, 33). While, one displacer piston (1) is moving toward the hot zone (3), pushing hot gas through pipe (11) to the counterflow heat exchanger channel (13) and through other pipe (12) to the cold zone (4), the other displacer piston (21) moves towards the cold zone (24), pushing gas through pipe (32) to the counterflow heat exchanger channel (33) and through other pipe (31) to the hot zone (23). During the displacer piston movement, hot gas, flowing within the counterflow heat exchanger channel (13) is transferring heat through the separation (18) to the cold gas, flowing in the other direction within the opposite channel (33). At the same time, redirecting valve (9) is switching from horizontal to vertical position, disabling gas from flowing through pipe (8)

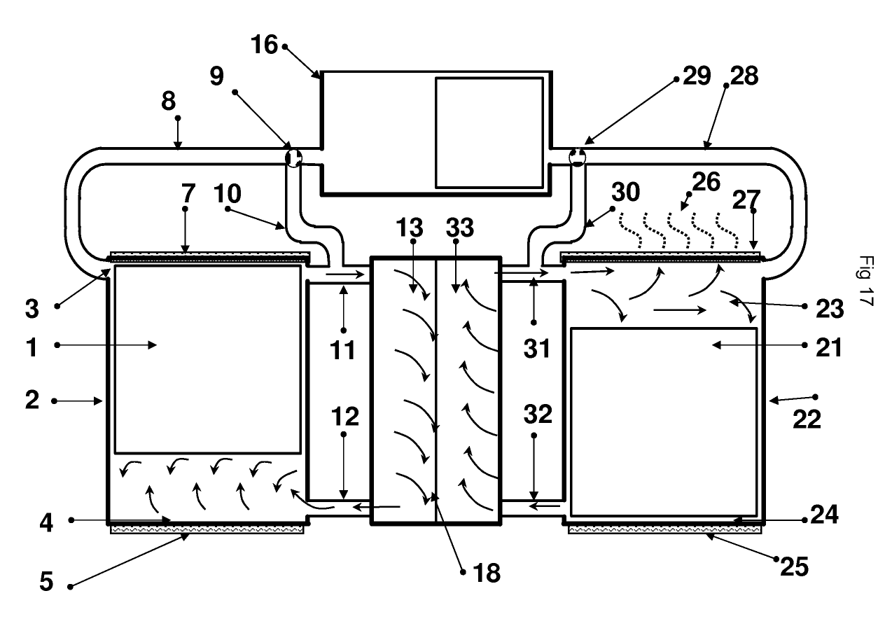

Stage C of the cycle is described in FIG. 17. During this stage, displacer pistons are placed at opposite positions. One displacer piston (1) is placed at the hot zone (3) while the other displacer piston (21) is placed at the cold zone (24). Hot gas, previously conveyed from the hot zone (3), is than transferring most of its heat to the cold gas, previously conveyed from cold zone (24). Accordingly, part of the heat from the hot gas was transferred to what used to be the cold gas in the previous stage. After reaching the cold zone (4), hot gas temperature is much lower than in previous stage, while the temperature of what used to be the cold gas, is much higher. The rest of the heat energy left in what used to be the hot gas, is dissipated within the cold zone (4), through the heat exchanger means (5), out to the reservoir. At the same time, what used to be the cold gas, is quickly heated. Heat flows from the heat source (26), through the heat exchanger means (27) and into the gas trapped within hot zone (23). At the same time, when displacers arrived to their extreme points, valve (29), located within the branching of pipes (30, 29), is switched to horizontal position, enabling expanding gas in the hot zone (23) flowing through the pipe (28) to the right input of work machine (16).

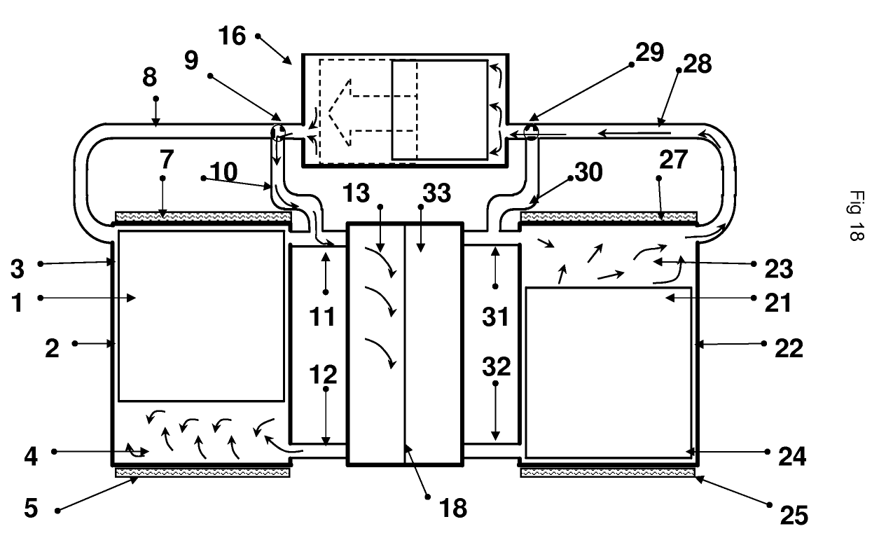

Stage D of the cycle is described in FIG. 18. In essence, all processes taking place within this stage are identical to those in stage A. Heated gas located within the hot zone (23) expands due to heat flowing from heat source (26) through the heat exchanger means (27), developing the high pressure on the right input of the work machine (16). Simultaneously the pressure drops from the other side of the work machine (16). As a result the compressed gas flow through the valve (9), pipe (10), and the counterflow heat exchanger channel (13) to the cold zone (4).

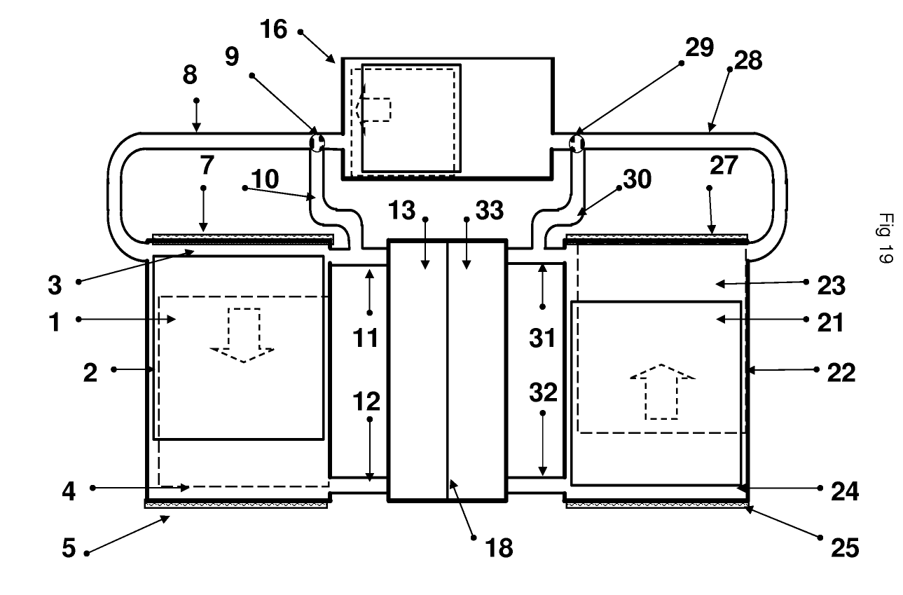

Stage E of the cycle is described in FIG. 19. In essence, all processes taking place within this stage are identical to those in stage B. Displacer pistons, moves to opposite directions, forcing gas to drive through the counterflow heat exchanger. While, one displacer piston (21) is moving toward the hot zone (23), pushing hot gas through pipe (31) to the counterflow heat exchanger channel (33) and through other pipe (32) to the cold zone (24), the other displacer piston (1) moves towards the cold zone (4), pushing gas through pipe (12) to the counterflow heat exchanger channel (13) and through other pipe (11) to the hot zone (3). During the displacer piston movement, hot gas, flowing within the counterflow heat exchanger channel (33) is transferring heat through the separation (18) to the cold gas, flowing in the other direction within the opposite channel (13). At the same time, valve (29) is switching from horizontal to vertical position, disabling gas from flowing through pipe (28).

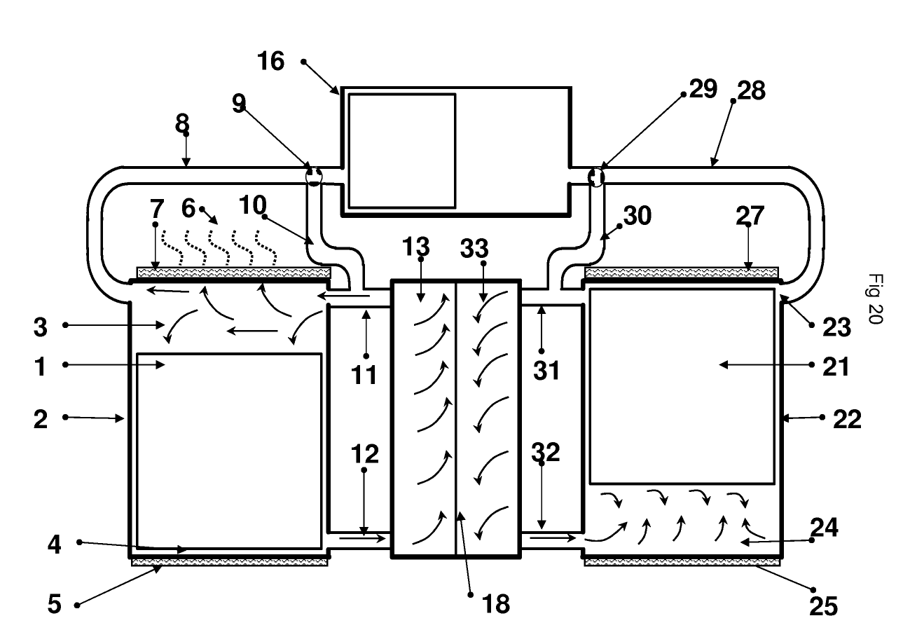

Stage F of the cycle is described in FIG. 20. In essence, all processes are taking place within this stage are identical to those in stage C. During this stage, displacer pistons are placed at opposite positions. One displacer piston (21) is placed at the hot zone (23) while the other displacer piston (1) is placed at the cold zone (4). Hot gas, previously conveyed from the hot zone (23), is than transferring most of its heat to the cold gas, previously conveyed from cold zone (4). After arriving to the cold zone (24), hot gas temperature is much lower than in previous stage, while the temperature of what used to be the cold gas, is much higher. The rest of the heat is dissipated within the cold zone (24), through the heat exchanger means (25), out to the reservoir. At the same time, heat flows from the heat source (6), through the heat exchanger means (7) and into the gas trapped within hot zone (3). At the same time, when displacers arrived to their extreme points, valve (9), located within the branching of pipes (10, 8), is switched to horizontal position, enabling expanding gas in the hot zone (3) flowing through the pipe (8) to the left input of the work machine (16).The method of operation as a heat pump is symmetrical to the method of the heat engine

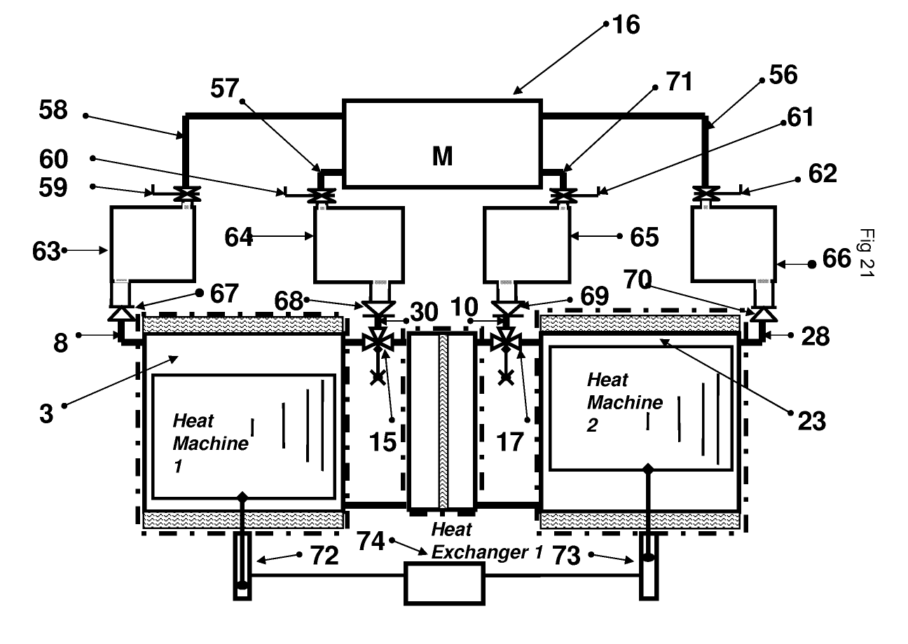

Another possible variation of the said invention is described in FIG. 21. An intermediate system of pressure tanks are inserted between the displacer units and work machine (16) enabling controllable transmitting pressure variations to work machine (16) regardless of the engine cycle's phase. In this configuration, power is distributed along the cycle, making work production smoother. High pressure tanks (63, 66) are connected through conduits (58, 8, 56, 28) to the work machine (16) and to the hot zones (3, 23); and low pressure tanks (64, 65) are connected through conduits formed by pipes (57, 30, 71, 10) to work machine (16), counterflow heat exchanger, and hot zones. Redirecting valves (15, 17) are switching gas flows in their conduits in accordance with their predefined scenario. Check valves (67, 70) define the direction of gas flow to the high pressure tanks (63, 66); check valves (68, 69) define the direction of gas flow from low pressure tanks (64, 65). Valves (59, 60, 61, 62) are controlled by the controlling device; pressure variations are received by the work machine (16) at the rate determined by the control unit. In this embodiment of the invention the frequency of displacer units motion can be different from the frequency of the work machine piston motion. The working machine can be implemented as one of the following types: reciprocating machine, unilateral machine like gear or rotary device.

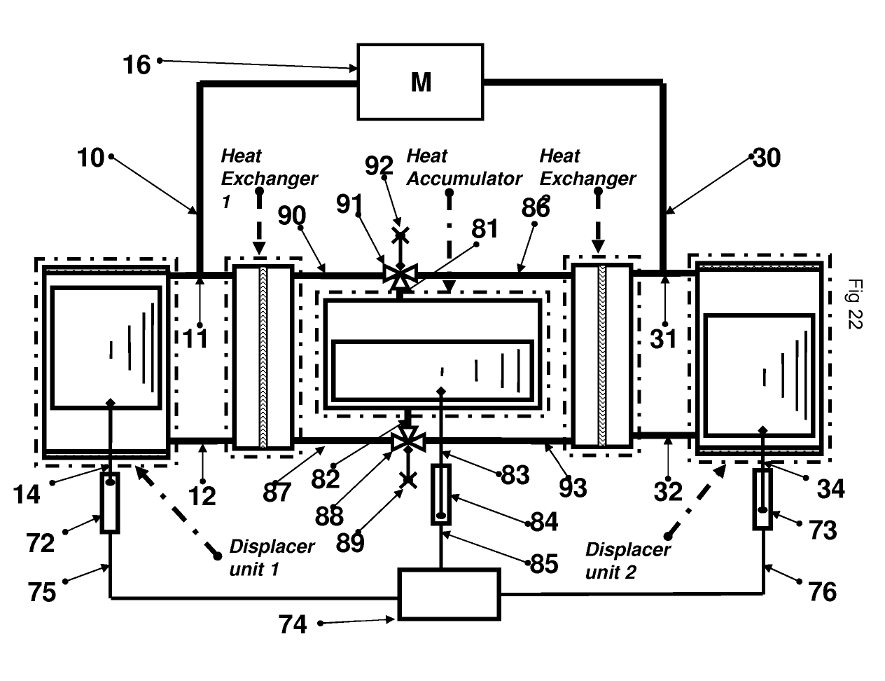

FIG. 22 represents another variation of energy conversion device according to one embodiment of this invention. The device presents combination of two displacer units coupled with heat accumulator through the counterflow heat exchangers and allows improved adjustment of power output. The device includes two displacer units (Displacer unit 1, Displacer unit 2), two heat exchangers (Heat Exchanger 1, Heat Exchanger 2), heat accumulating device (Heat Accumulator), actuating drives for displacing elements (14, 34, 83), controlling device comprised of process manager unit (74) with control drives (75, 76, 85) and actuating devices (72, 73, 84), redirecting valves (91, 88) with drives (89, 92) controlled by process manager unit (74), connecting conduits.

Heat Exchanger 1 is inserted between each Displacer unit 1 and Heat Accumulator; Heat Exchanger 2 is inserted between each Displacer unit 2 and Heat Accumulator. Conduit, formed by pipes (90, 86, 81) connects the hot zone of Heat Accumulator through redirecting valve (91) to both heat exchangers. Redirecting valve (91) is controlled by the controlling device with the drive (92) and redirects the flow of heat carrier through pipes (81, 90) or through pipes (81, 86) depending on phase of regenerative cycle of the energy conversion device. Conduit, formed by pipes (87, 82, 93) connects the cold zone of Heat Accumulator through redirecting valve (88) to both heat exchangers. Redirecting valve (88) is controlled by the controlling device with the drive (89) and redirects the flow of heat carrier through pipes (82, 87) or through pipes (82, 93) depending on phase of regenerative cycle of the energy conversion device. Conduit, formed by pipes (10, 11), connects the hot zone of the Displacer unit 1, Heat Exchanger 1 and work machine (16), conduit (12) connects the cold zone of Displacer unit 1 with the counterflow Heat Exchanger 1, thereby enabling the flow of fluid from the hot to cold zone of Displacer unit 1 through the counterflow Heat Exchanger 1, and enabling for work machine (16) to transmit or receive variations of pressure. Conduit, formed by pipes (30, 31), connects the hot zone of the Displacer unit 2, Heat Exchanger 2 and work machine (16), conduit (32) connects the cold zone of Displacer unit 2 with the counterflow Heat Exchanger 2, thereby enabling the flow of fluid from the hot to cold zone of Displacer unit 2 through the counterflow Heat Exchanger 2, and enabling the work machine (16) to transmit or receive variations of pressure. The controlling device comprised of process manager unit (74) and its drives (75, 76, 85), actuating devices (72, 73, 84) and its drives (14, 34, 83). The said controlling device synchronizes the proper switching of valves (88, 91) and motion of displacers to provide the proper flow of heat carrier and fluids through counterflow heat exchangers according to the above-stated method.

It will be seen from the above description of this invention that it provides a method and device which fulfills the objects set forth. By combining the counterflow heat exchanger and redirecting valves in the described way, a greater part of the heat energy is economically conserved, providing greater efficiency. Moreover, the coupling of two identical displacer units in the said way, provides a smoother work energy generation. There is, therefore, a combination of factors which materially contribute to the attainment of efficiencies higher than previously possible in heat engines, and which extends the range of applications

Numerous characteristics, advantages and embodiments of the invention have been described in detail in the foregoing description with reference to the accompanying drawings. However, the disclosure is illustrative only and it is to be understood that the invention is not limited to the precise illustrated embodiments. Various changes and modifications may be effected therein by one skilled in the art without departing from the scope or spirit of the invention.

What is claimed is:

1. An energy conversion device implementing regenerative gas cycle, said energy conversion device comprised of:
a work machine that is capable of receiving and transmitting variations of pressure
at least two displacer units each including a hot and cold zone and a displacer element for moving an actuating medium from the hot zone to the cold zone;
at least one counterflow heat exchanger for enabling heat exchange between actuating mediums of displacer units, wherein the actuating medium of the displacers units flows through the counterflow heat exchanger from the hot zone to the cold zone and vice versa;
controlling device capable of controlling the movement of displacers elements; and;
at least four conduits for connecting between the counterflow heat exchanger to the displacer units.

2. The device of claim 1 further comprising a heat source, wherein one of the displacing units is connected to the heat source on one end and other end connected to reservoir and a second displacing unit functions as a heat accumulator, wherein the work machine further includes at least one input for receiving pressure variations generated by the first displacing unit, wherein the device operates as a heat engine.

3. A method for converting and regenerating heat energy implemented within the device of claim 2, said method comprising the following successive phases:
The fluid enclosed in the hot zone of the first displacer unit, is being heated and expanded, thereby high pressure is being received at the work machine input, wherein the heat carrier is enclosed in the cold zone of the heat accumulator, preserving low temperature heat energy for the determined time interval;
the fluid is being moved to the cold zone of the first displacer unit, through the counterflow heat exchanger, wherein part of the fluid heat energy is transferred to the heat carrier, said heat carrier is being moved in the opposite direction to the fluid flow, through the thermally coupled channel of the said counterflow heat exchanger;
The fluid enclosed in the cold zone of the heat machine, is being cooled and compressed, thereby low pressure is being received at the work machine input, wherein simultaneously the heat carrier is enclosed in the hot zone of the heat accumulator, preserving high temperature heat energy for the determined time interval;
the fluid is being moved to the hot zone of the heat machine, through the counterflow heat exchanger, absorbing part of the heat energy of the heat carrier, said heat carrier is being moved in the opposite direction through the thermally coupled channel of the said heat exchanger

4. The device of claim 1 wherein the first displacing unit receives pressure variations from the work machine and the second displacing unit functions as a heat accumulator, wherein the work machine further includes at least one output for transmitting the pressure variations generated by the said work machine, wherein the device operates as a heat pump providing transfer of the heat from the heat exchange surface of the cold zone to the heat exchange surface of the hot zone of the said heat machine.

5. A method for converting and regenerating heat energy implemented within the device of claim 4, said method comprising the following successive phases:
The fluid enclosed in the hot zone of the first displacer unit, is being compressed as a result of the high pressure transmitted from the output of the work machine, thereby said fluid is heated and the heat energy is delivered to the hot zone of the heat exchanger surface of the first displacer unit, wherein the heat carrier is enclosed in the cold zone of the heat accumulator, preserving low thermal energy for the determined time interval;
the fluid is being moved to the cold zone of the first displacer unit, through the counterflow heat exchanger, wherein part of the fluid heat energy is transferred to the heat carrier, said heat carrier is being moved in the opposite direction to the fluid flow, through the thermally coupled channel of the said counterflow heat exchanger;
The fluid enclosed in the cold zone of the first displacer unit, is being expanded as a result of the low pressure transmitted from the outlet of the work machine, thereby said fluid is being cooled and absorbing heat energy from the heat exchanger surface of cold zone, wherein simultaneously the heat carrier is enclosed in the hot zone of the heat accumulator preserving high thermal energy for the determined time interval;
the fluid is being moved to the hot zone of the first displacer unit, through the counterflow heat exchanger, absorbing part of the heat energy of the heat carrier, said heat carrier is being moved in the opposite direction through the thermally coupled channel of the said heat exchanger

6. The device of claim 1 further comprising a heat source, wherein the work machine further includes at least two inputs for receiving the pressure variations generated by the said displacer units, wherein the device operates as a heat engine.

7. A method for converting and regenerating heat energy implemented within the device of claim 6, said method comprising the following successive phases:
The fluid enclosed in the hot zone of the first displacer unit, is being heated and expanded, thereby high pressure is received at first input of the work machine, wherein the fluid is enclosed in the cold zone of the second first displacer unit, is being cooled and compressed, thereby low pressure is received at the second input of the work machine t;
the fluid of the first displacer unit is being moved from the hot to the cold zone of the first displacer unit, through the counterflow heat exchanger, wherein part of its heat energy is transferred to the fluid of the second displacer unit, said fluid of the first displacer unit is being moved in the opposite direction to the fluid flow of the second displacer unit, said fluid of the second displacer unit is being moved from the cold to the hot zone of the second displacer unit through the thermally coupled channel of the said counterflow heat exchanger;
The fluid enclosed in the cold zone of the first displacer unit, is being cooled and compressed, thereby low pressure is received at the first input of the work machine, wherein the fluid enclosed in the hot zone of the second displacer unit, is being heated and expanded, thereby high pressure is received at the second input of the work machine;
the fluid of the first displacer unit is being moved from the cold to the hot zone of the first displacer unit, through the counterflow heat exchanger, wherein part of the heat energy is absorbed from the fluid of the second displacer unit, said fluid of the first displacer unit is being moved in the opposite direction to the fluid flow of the second displacer unit, said fluid of the second displacer unit is being moved from the hot to the cold zone of the second displacer unit through the thermally coupled channel of the said counterflow heat exchanger;

8. The device of claim 1, wherein the work machine further includes at least two outlets for transmitting pressure variations generated by the work machine, wherein the device operates as a heat pump providing transfer of the heat from the heat exchange surface of the cold zones to the heat exchange surface of the hot zones of the said displacer units.

9. A method for converting and regenerating heat energy implemented within the device of claim 8, said method comprising the following successive phases:
the fluid enclosed in the hot zone of the first displacer unit is being compressed as result of the high pressure transmitted from the first output of the work machine, thereby said fluid is being heated and the heat energy is delivered to the hot zone of the heat exchange surface of the first displacer unit, wherein the fluid enclosed in the cold zone of the second displacer unit is expanding as result of low pressure transmitted from the second output of the work machine, thereby said fluid is being cooled and absorbing heat energy from the cold zone heat exchange surface of the second displacer unit;
the fluid of the first displacer unit is being moved from the hot to the cold zone of the first displacer unit, through the counterflow heat exchanger, wherein part of the heat energy of the first displacer unit fluid is transferred to the fluid of the second displacer unit, said fluid of the first displacer unit is being moved in the opposite direction to the fluid flow of the second displacer unit, said fluid of the second displacer unit is being moved from the cold to the hot zone of the second displacer unit through the thermally coupled channel of the said counterflow heat exchanger;
the fluid enclosed in the cold zone of the first displacer unit is expanding as result of the low pressure transmitted from the first output of the work machine, thereby said fluid is cooled and the heat energy is absorbed from the cold zone of the heat exchanger surface of the first displacer unit, wherein the fluid enclosed in the hot zone of the second displacer unit is being compressed as result of high pressure transmitted from the second output of the work machine, thereby said fluid is being heated , delivering heat energy to the hot zone heat exchange surface of the second displacer unit;
the fluid of the first displacer unit is being moved from the cold to the hot zone of the first displacer unit, through the counterflow heat exchanger, wherein part of the heat energy is absorbing from the fluid of the second displacer unit, said fluid of the first displacer unit is being moved in the opposite direction to the fluid flow of the second displacer unit, said fluid of the second displacer unit is being moved from the hot to the cold zone of the second displacer unit through the thermally coupled channel of the said counterflow heat exchanger;

10. The energy conversion device in accordance with claim 1 wherein the controlling device is comprised of: a process management unit, and an operating mechanism, said operating mechanism is implemented of as one of the following types electric, hydraulic, pneumatic, mechanic, wherein the operating mechanism is activated by signals of the said a process managing unit, providing synchronous and countercurrent flows of fluid in the said heat exchanger.

11. The energy conversion device in accordance with claim 1 wherein the controlling device is a kinematical mechanism.

12. A method for controlling of the displacer elements reciprocating movement implemented in device in accordance with claim 1, wherein the each of the displacer elements movement is controlled independently thereby the countercurrent flow of fluids in the different channel of said heat exchanger is controlled independently.

13. A method for controlling of the displacer elements reciprocating movement implemented in device in accordance with claim 1, wherein the displacer elements movement is synchronized, thereby the countercurrent flow of fluids in the different channel of said heat exchanger is synchronized.

14. The method for controlling of the displacer elements reciprocating movement implemented in device in accordance with claims 1, wherein the displacing elements are piston-displacers, said method include the following: controlling the time interval of holding the piston-displacers in the cold zone or the hot zone of their displacer units, thereby, changing the ratio of the duty cycle reciprocating motion of the said displacing elements.

15. The device of the claim 1 wherein the counterflow heat exchanger is constructed with the increased thickness of walls, thereby allowing to increase thermal capacity of mass of walls of the said counterflow heat exchanger and to keep the sufficient amount of the heat energy enabling alternate and intermittent flows of the actuating mediums.

16. The device of the claim 1 wherein the counterflow heat exchanger is crafted from the material of specific anisotropy of heat conductance to achieve less thermal resistance across the walls of separating channels of opposite fluid flows than the thermal resistance along the walls of separating channels of opposite fluid flows, thereby, obtaining reduction of total length of the said counterflow heat exchanger and decreasing the resistance of the fluid flow through the channels of the said heat exchanger

17. The energy conversion device of claim 1 further including additional conduit connecting between the work machine and at least one displacer unit.

18. The energy conversion device of claim 17 further including at least one redirecting valve within the each conduit and additional conduits connecting between the opposite sides of the hot zone of the displacers unit.

19. The energy conversion device of claim 18 wherein said redirecting valve is controlled by a control unit.

20. The energy conversion device of claim 18 wherein an external control unit change redirecting valve position in accordance with predefined scenario which is designed to effect the energy conversion device cycle for achieving optimal efficiency of heat energy usage within the energy conversion device.

21. The energy conversion device of claim 1 further comprising at least two high pressure tank and at least two low pressure tank, each tank connected between at least one displacer unit and the working machine; said tanks are connected with conduits equipped with valves.

22. A method for controlling the transmission of pressure variations between the working machine and at least one displacing unit of the device in accordance with claim 21 enabling asynchronized movement of the working machine and the displacer units, wherein said control is achieved by managing the operation of valves.

23. The energy conversion device of claim 1 wherein the working machine is one of the following types: reciprocating machine, unilateral machine like gear or rotary device.

24. The device of claim 1 further comprising at least one heat source, at least one work machine, at least two counterflow heat exchangers, at least three displacer units, wherein one displacer unit functions as a heat accumulator, wherein first displacer unit is coupled with said heat accumulator through first heat exchanger, wherein second displacer unit is coupled with said heat accumulator through second heat exchanger, wherein the work machine further includes at least t two inputs for receiving pressure variations generated by a displacer unit, wherein the device operates as a heat engine.

25. The device of claim 1 further comprising at least one heat source, at least one additional? work machine, at least two counterflow heat exchangers, at least three displacer units, wherein one displacer unit function as a heat accumulator, wherein first displacer unit is coupled with said heat accumulator through first heat exchanger, wherein second displacer unit is coupled with said heat accumulator through second heat exchanger, wherein the work machine further includes at least one outlet for transmitting pressure variations generated by said work machine, wherein the device operates as a heat pump providing transfer of the heat from the heat exchange surface of the cold zones to the heat exchange surface of the hot zones of the said displacer units.

26. A method of intermediate storage and regeneration of heat energy implemented within the device of claim 24 and 25, said method comprising the following phases:
preserving low temperature heat energy for the determined time interval when the fluid is enclosed in the hot zone of the first displacer unit and the heat carrier is enclosed in the cold zone of the heat accumulator;
the fluid of the first displacer unit is being moved from the hot to the cold zone of the first displacer unit, through the first counterflow heat exchanger, wherein part of heat energy is transferred to the heat carrier of the heat accumulator, said fluid of the first displacer unit is being moved in the opposite direction to the heat carrier flow of the heat accumulator and the fluid of the heat accumulator is being moved from the cold to the hot zone of the heat accumulator through the thermally coupled channel of the said first counterflow heat exchanger;
preserving high temperature heat energy for the determined time interval when the fluid is enclosed in the cold zone of the first displacer unit, and the heat carrier is enclosed in the hot zone of the heat accumulator;
the fluid of the second displacer unit is being moved from the cold to the hot zone of the second displacer unit, through the second counterflow heat exchanger, wherein part of heat carrier heat energy of the heat accumulator is being absorbed by the fluid of the second displacer unit, said fluid of the second displacer unit is being moved in the opposite direction to the heat carrier flow of the heat accumulator, wherein the heat carrier of the heat accumulator is being moved from the hot to the cold zone of the heat accumulator through the thermally coupled channel of the second counterflow heat exchanger;
preserving low temperature heat energy for the determined time interval when the fluid is enclosed in the cold zone of the second displacer unit and the heat carrier is enclosed in the hot zone of the heat accumulator;
the fluid of the first displacer unit is being moved from the cold to the hot zone of the first displacer unit, through the first counterflow heat exchanger, wherein part of heat energy is being absorbed from the heat carrier of the heat accumulator, said fluid of the first displacer unit is being moved in the opposite direction to the heat carrier flow of the heat accumulator and the fluid of the heat accumulator is being moved from the hot to the cold zone of the heat accumulator through the thermally coupled channel of the said assigned counterflow heat exchanger;
preserving low temperature heat energy for the determined time interval when the fluid is enclosed in the hot zone of the second displacer unit, wherein the heat carrier is enclosed in the cold zone of the heat accumulator;
the fluid of the second displacer unit is being moved from the hot to the cold zone of the second displacer unit, through the second counterflow heat exchanger, wherein part of the second displacer unit fluid heat energy is transferred to the heat carrier of the heat accumulator, said fluid of the second displacer unit is being moved in the opposite direction to the heat carrier flow of the heat accumulator, wherein the heat carrier of the heat accumulator is being moved from the cold to the hot zone of the heat accumulator through the thermally coupled channel of the said assigned counterflow heat exchanger;

27. The device of claim 1 wherein the counterflow heat exchanger is comprised of two identical heat exchanging elements that enable countercurrent gas flow, and separation wall that physically isolates channels but enables heat exchange between countercurrent flowing of fluid and heat carrier within these channels.
